(19) United States
(12) Patent Application Publication
(10) Pub. No.: US 2003/0110107 A1
(43) Pub. Date: Jun. 12, 2003

(54) Delayed start financial instrument and method for converting delayed start financial instrument to a standard option

(76) Inventors: John C. Hiatt JR., Woodbridge, IL (US); Dominic J. Salvino, Naperville, IL (US); William M. Speth, Evanston, IL (US)

Correspondence Address: BELL, BOYD & LLOYD, LLC, PO BOX 1135, CHICAGO, IL, 60690-1135, US

(21) Appl. No.: 10/017,040

(22) Filed: Dec. 6, 2001

(51) Int. Cl. G06F 17/60

(52) U.S. Cl. 705/35

(57) ABSTRACT

The present invention relates to a financial instrument adapted to be traded on an exchange. The invention further encompasses a method of creating such a financial instrument and converting it, on a predetermined date, into a standard option of a type listed and traded on the exchange. The financial instrument is a delayed start option having a variable strike price equal to the value of an underlying asset during a time period prior to a strike price setting date defined by the instrument. On the strike price setting date the delayed start option is converted to one of the standard options listed on the exchange having a fixed strike price.

### BACKGROUND OF THE INVENTION

The present invention relates to a financial instrument that may be traded on an exchange or other trading facility (hereafter simply “an exchange”). Specifically, the invention relates to a delayed start option that may be listed on an exchange along with a plurality of other standard options. The invention also includes a method for converting a delayed start option into one of the standard options listed on the exchange at a strike price determined on a predetermined strike price setting date.

Options are well known financial instruments. An option is a contract giving the holder of the option the right, but not the obligation, to buy or sell an underlying asset at a specific price on or before a certain date. A party who purchases an option may be referred to as the holder of the option and a party who sells an option may be referred to as the writer of the option. There are two types of options: call options and put options. The holder of a call option receives the right to purchase the underlying asset at a specific price known as the “strike price.” The holder of a put option receives the right to sell the underlying asset at a specific price, again referred to as the strike price. The rights and obligations of the holders and writers of options may be transferred to others. In fact, large trading facilities including exchange markets have been established to facilitate trading options. In the vernacular of such exchanges, the holder of an option contract is said to have taken a long position, and the writer of the option is said to have taken a short position.

If the holder of a call option elects to exercise the option, i.e., if the holder decides to purchase the underlying asset at the agreed upon strike price, the writer is obligated to deliver the underlying asset to the holder. Similarly, if the holder of a put option elects to exercise, the writer is obligated to purchase the underlying asset at the agreed upon strike price, and the holder delivers the underlying asset to the writer of the option. Thus, the settlement process involves the transfer of funds from the purchaser of the underlying asset (the holder of a call option or the writer of a put option) to the seller (the writer of a call option or the holder of a put option) and the transfer of the underlying asset (a number of shares of stock, a quantity of a commodity, and so forth) from the seller to the purchaser. This type of settlement may be referred to as “in kind” settlement.

The underlying asset of an option, however, need not necessarily be a tangible, transferable property. Rather, options may be based on more abstract market indicators, such as stock indices, interest rates, futures contracts and other derivatives. In these cases, in kind settlement is not possible, since the concept of delivering the underlying asset is meaningless. In these situations cash settlement is employed. Cash settlement of an index option is illustrative. A holder of an index call option receives the right to “purchase” the index at the strike price defined by the option. The holder receives the right to “purchase” not the index itself, but rather a cash amount equal to the value of the index multiplied by a multiplier such as $100. Thus, if a holder of an index call option elects to exercise the option the writer of the option is obligated to pay the holder the difference between the current value of the index and the strike price multiplied by the multiplier. That is, assuming that the current value of the index is greater than the strike price. If it is not, the option is worthless. Similarly, if the holder of an index put option elects to exercise the option the writer is obligated to pay the holder the difference between the current value of the index and the strike price. In this case, the assumption is that the current value of the index is less than the strike price of the option. If it is not, the option is worthless.

Options may be traded over-the-counter, or on organized exchanges (or other trading facilities). In over-the-counter transactions, the individual parties to a transaction are free to customize each transaction as they see fit. With exchange traded options, a clearing corporation stands between the holders and writers of options. The clearing corporation matches buyers and sellers and settles the trades. Thus, cash or the underlying assets are delivered, when necessary to the clearing corporation and the clearing corporation disperses the assets as necessary as a consequence of the trades. Under the rules of the clearing corporation and the exchange, however, exchanges are limited to listing only a limited number of standard options contracts. Typically, such standard options will be listed as different series expiring each month and representing a number of different incremental strike prices. The size of the increment in the strike price will be determined by the rules of the exchange, and will typically be related to the value of the underlying asset.

In general, options may be considered volatility investment products.

Volatility in the value of the underlying asset, or more precisely, the expected volatility of the value of the underlying asset is an important factor in determining the price of an option. At present, there is no exchange traded investment product that provides clean exposure to volatility. In 1993, the Chicago Board Options Exchange developed the Market Volatility Index (VIX). The VIX represents the implied volatility of a hypothetical at-the-money option with thirty days to expiration. Implied volatility is the volatility input that makes the theoretical price of an option equal its actual market price. The index highlights the relationship between the price of options and the implied volatility. The VIX is calculated using a weighted average of the implied volatilities of at-the-money and near at-the money S&P 100 index (OEX) options. At-the-money and near at-the-money options are used because they are the most sensitive to changes in implied volatility.

For some time there has been a desire for a volatility investment product based on VIX options. However, market participants have expressed reservations about such a product because of the inherent difficulties in hedging investments in such a product. Specifically, it would be very difficult and costly for an investor to maintain a portfolio of standard at-the-money options with an average of thirty days to expiration.

Forward start options, a specialized type of option which has been traded over-the-counter, provide a solution to this problem. Forward start options provide a simple cost-effective way to hold a constant portfolio of at-the-money options. Forward start options also provide a way to trade forward volatility—the market's expectation of implied volatility at different points along the volatility term structure. In other words, how the implied volatility varies with time as the option approaches expiration. A forward start option is similar to a conventional option encompassing both calls and puts, but unlike a conventional option, the strike price, the price at which the option holder has the right to purchase or sell the underlying asset, is not fixed. A forward start option begins trading with a floating strike price that reflects the value of the underlying asset. [Note: The rest of the paragraph is too specific—all that remains to be said about the OTC forward start options is that the strike price is fixed on a predetermined date.]

When the forward start option is created, a date is specified on which the strike price will be set. The date may be selected to be one month, two months, or some other length of time prior to the expiration date of the option. When the strike price is set, it is set at a price that reflects the current value of the underlying asset. For example, the strike price may be set to the closing value of the underlying asset on the day prior to the day on which the strike price is set. Thus, prior to the date on which the strike price is set, the forward start option represents an at-the-money option with a predefined period of time to expiration, regardless of fluctuations in the price of the underlying asset. By maintaining a portfolio to several forward start options an investor may capture the implied volatility of an option based on the underlying asset some time into the future.

From the above discussion, it is clear that a standardized forward start option product traded on an exchange would be a great benefit to investors. However, there are obstacles toward developing such an exchange-based product that are not present with forward start options traded in the over-the-counter market. Only a finite number of standard options are listed and traded on an exchange, whereas in the over-the-counter market each contract may be unique. Thus, with forward start options traded over the counter there is no difficulty when the strike price is set on the strike price setting date. Whatever the closing value of the underlying asset is on the strike setting date becomes the strike price of the option thereafter. This newly created strike price may fall between the strike prices of the standard options traded on an exchange. Thus, if forward start options were traded on an exchange entire new series of options would be created each time the strike price of a forward start option was set to some new anomalous value. There would not be a ready market for these new options having unconventional strike prices. Furthermore, simply keeping track of and listing all of these proliferating contracts would be difficult and expensive. Because the over-the-counter model of forward start options is not readily adaptable to an exchange traded product, a need exists for developing a volatility product that may be traded on an exchange which captures the implied volatility of an at-the-money option with three months to expiration.

### SUMMARY OF THE INVENTION

The present invention provides a financial instrument in the form of a delayed start option that may be traded on an exchange on which a plurality of standard options are traded and a method of converting a forward start option into one of the standard options traded on the exchange. A delayed start option according to the invention provides a holder of the option the right, but not the obligation, either to buy (a call option) or sell (a put option) a stake in the underlying asset at a strike price to be determined on a strike price setting date. Prior to the strike price setting date, the strike price of the delayed start option floats with the value of the underlying asset. On the strike price setting date the strike price is fixed, and the delayed start option is converted to one of the standard options traded on the exchange. In a preferred embodiment of the invention, the particular standard option to which the delayed start option is converted is determined by selecting the standard option having a fixed strike price nearest to the value of the underlying asset on the strike price setting date.

The present invention also provides a method of creating a delayed start option that will be at-the-money on a strike price setting date that occurs a predefined period of time prior to expiration of the option. The delayed start option may be held and traded prior to the strike price setting date. After the strike price setting date the delayed start option converts to one of the standard options listed on the exchange. The method includes a number of steps. The first step is selecting an underlying asset having a variable value. The underlying asset may be a security, such as a stock or exchange traded fund, a commodity, or some other tangible asset. The underlying asset may also be market index, an interest rate, a derivative such as a future, or any other market indicator that reflects market conditions and may be expected to change over time. Another step in the method involves listing a number of standard options to either buy or sell a stake in the underlying asset at a fixed strike price. The order in which the first two steps are performed are not necessarily relevant. A third step involves creating a delayed start option to either buy or sell a stake in the underlying asset at a strike price to be determined on a predefined strike setting date in the future. The fourth step involves converting the delayed start option to one of the standard options listed on the exchange. The particular standard option selected from among the standard options listed by the exchange is the standard option having a fixed strike price at or near the value of the underlying asset on the strike price setting date. In this way, a substantially at-the-money standard option is created from the delayed start option on the strike price setting date. By purchasing a series of delayed start options, all expiring in different months, an investor can easily and efficiently maintain an entire portfolio of a the money options with a set time to expiration.

An additional feature of the inventive method of converting a delayed start option to a standard option is a step of allocating the difference in value between an option having a strike price equal to the value of the underlying asset and the value of the standard option to which the delayed start option is converted between the party who is “long” the option, and the party who is “short” the option. According to an embodiment of the invention, the difference in value between the delayed start option with a strike price exactly equal to the value of the underlying asset and a standard option with a strike price near the value of the underlying asset is calculated by taking the difference between the closing value of the underlying asset on the day preceding the strike price setting date and the fixed strike price of the standard option to which the delayed start option is converted, multiplying the difference by one half, and then multiplying the resulting figure by some contract multiplier such as $100. When converting a delayed start call option, if the strike price of a standard call option is greater than the value of the underlying asset, this amount is credited to the party who is long and debited to the party who is short. If the strike price of a standard call option is less than the value of the underlying asset, the calculated amount is credited to the short party and debited to the long party. The above allocation process is exactly reversed for converting delayed start put options. If the strike price of a standard put option is greater than the value of the underlying asset, the calculated amount is debited to the long party and credited to the short party. On the other hand, if the strike price of a standard put option is less than the value of the underlying asset, the calculated amount is credited to the long party and debited to the short party.

Additional features and advantages of the present invention are described in, and will be apparent from, the following Detailed Description of the Invention and the figures.

### BRIEF DESCRIPTION OF THE FIGURES

FIG. 1. is a representation of a variable range of values of an underlying asset;

FIG. 2 is a listing of a representative standard option listed on an options exchange;

FIG. 3 is listing of a delayed start option according to the present invention;

FIG. 4 is a flowchart of a method of converting a delayed start option into a standard option according to a preferred embodiment of the invention.

### DETAILED DESCRIPTION OF THE INVENTION

The present invention relates to a financial instrument adapted to be traded on an exchange. Preferably, the instrument is traded on an options exchange on which a number of standard options are traded. The invention further encompasses a method of creating such a financial instrument and converting it, on a predetermined date, into one of the standard options listed by the exchange.

The financial instrument of the present invention may be generally described as a “delayed start option” and is a variant of the forward start option, traded in the over the counter market. As with a traditional option contract, a delayed start option contract is based on the value of an underlying asset. In this context, an “underlying asset” may be a security such as a stock or exchange traded fund, a commodity, or some other tangible asset. An “underlying asset” may also be market index, an interest rate, a derivative, or any other market indicator that reflects market conditions and may be expected to change over time. Again, as with traditional option contracts, the delayed start option contract of the present invention encompasses both calls and puts. Unlike standard option contracts, however, the delayed start contract does not include a fixed strike price. Rather, the strike price of the delayed start option is determined on a predefined strike price setting date that occurs in the future. Prior to the strike price setting date the strike price of the delayed start option floats according to the value of the underlying asset. On the strike price setting date the delayed start option contract is converted to one of the standard options listed by the exchange on which the delayed start option is traded. The forward start option is converted to the standard option having a strike price nearest the value of the underlying asset on the strike price setting date.

The strike price setting date is determined when the delayed start option is created. In a preferred embodiment, the strike price setting date will be three months prior to the expiration of the option. Prior to the strike price setting date a delayed start option, according to the preferred embodiment, represents an at-the-money option with three months to expiration. Of course, the strike price setting date may be set to some other date prior to the expiration of the option, such as thirty days or sixty days prior, as desired.

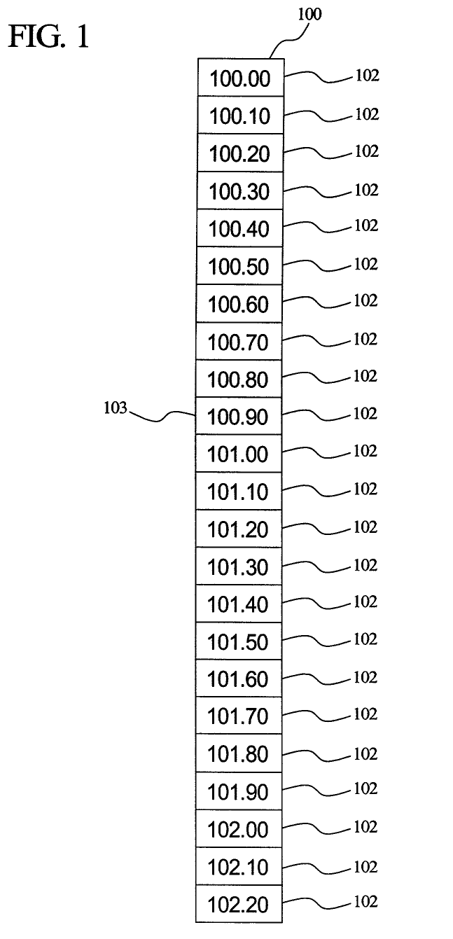

The mechanics of creating a forward start option according to the present invention and for converting it to a standard option contract on the strike price setting date will now be described with reference to FIGS. 1-3. FIG. 1 shows a range 100 of discrete values 102 that an underlying asset may take on over a period of time. As can be seen, the range 100 displayed in FIG. 1 extends from a lower value of 100.00 to an upper value of 102.20 in 0.10 increments. It should be noted that this range is shown for purposes of illustration only. An underlying asset may actually take on values that are significantly different than those shown, and which vary in a substantially continuous manner rather than the 0.10 increments shown. The individual values 102 displayed within the range 100 represent particular values of an underlying asset at a particular instant in time.

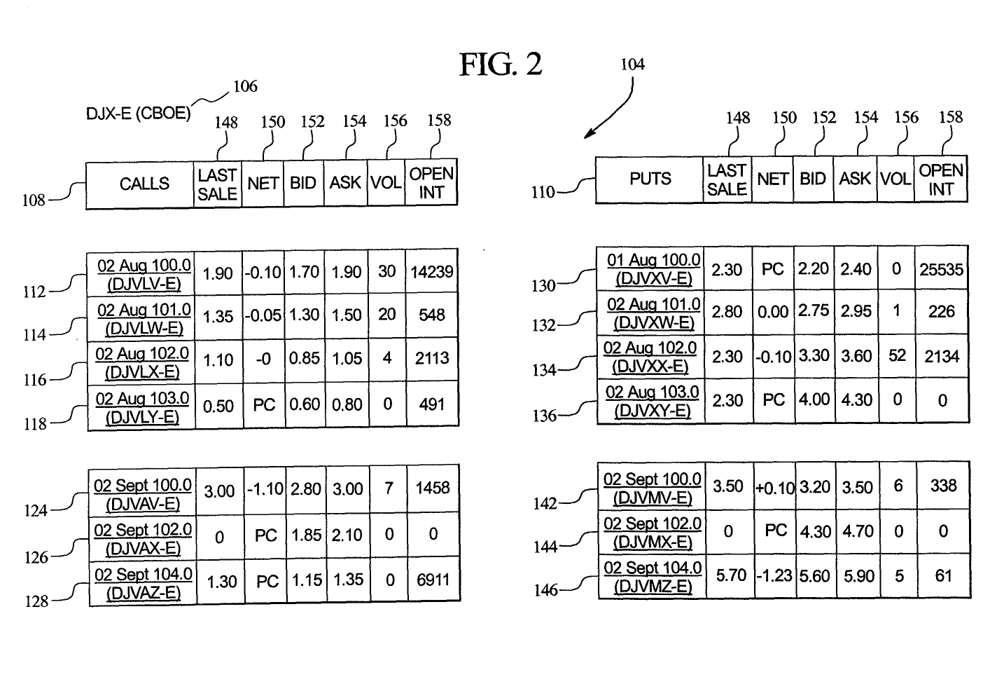

FIG. 2 shows a listing 104 of a number of standard option contracts that may be listed on an exchange. FIG. 2 includes a plurality of standard calls 108 and a plurality of standard puts 110. The options are based on a designated underlying asset 106. In the example shown in FIG. 2 the underlying asset is the Dow Jones Industrial Averages^{SM} (Dow Jones Index). In this case, the range of values 100 shown in FIG. 1 represent a range of possible values of the Dow Jones Index at any particular time.

The standard call options 108 displayed in FIG. 2 include options expiring in August 2002 and September 2002. The standard calls expiring in August include a call option 112 having a strike price of 100.00; a call option 114 with a strike price of 101.00; a call option 116 with a strike price of 102.00; and a standard call option 118 with a strike price of 103.00. The standard call options expiring in September include a standard call option 124 with a strike price of 100.00; a standard call option 126 with a strike price of 102.00; and a standard call option 128 with a strike price of 104.00. The standard put options expiring in August include a put option 130 with a strike price of 100.00; a put option 132 with a strike price of 101.00; a put option 134 with a strike price of 102.00; and a standard put option 136 with a strike price of 103.00. The standard put options expiring in September include a put option 142 with a strike price of 100.00; a put option 144 with a strike price of 102.00; and a put option 146 with a strike price of 104.00. The listing 104 includes additional data, such as the last sale 148, net 150, bid price 152, ask price 154, volume 156, and number of contracts of open interest for each standard option 158. The standard options expiring in a particular month expire according to the rules of the exchange. For example, the expiration date may be established as the Saturday following the third Friday of the designated month.

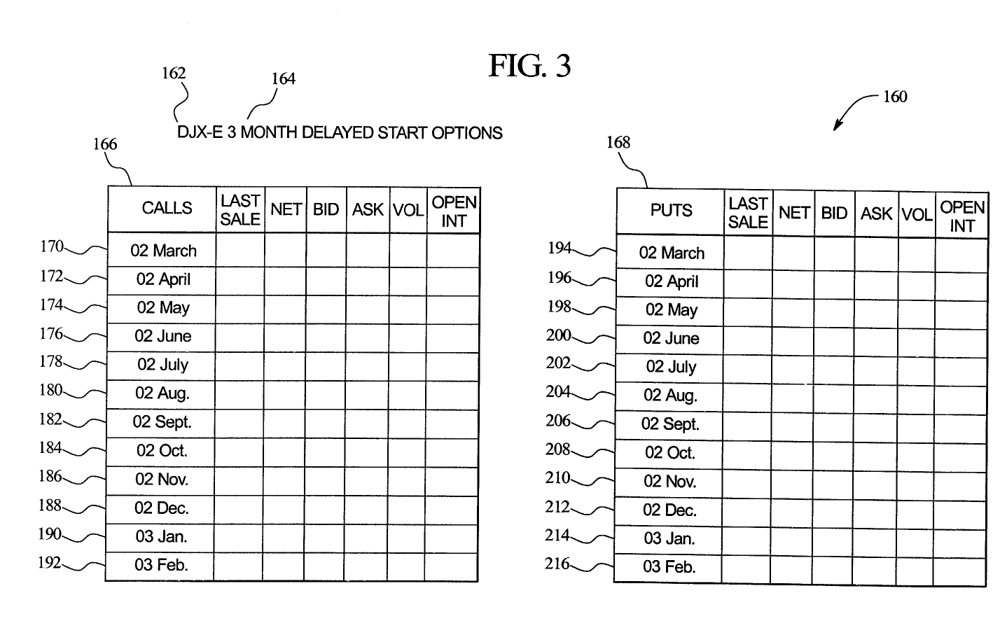

FIG. 3 shows a listing 160 of a plurality of delayed start options according to the present invention. The listing 160 identifies the underlying asset 162, in this case, the Dow Jones Index, and the strike price setting date 164 relative to the expiration. In this example, the strike price setting date is three months prior to expiration. As with the listing of standard options 104 shown in FIG. 2, the listing 160 includes both delayed start call options 166 and delayed start put options 168. Both the delayed start call options 166 and the delayed start put options 168 include options that expire in each month beginning in March 2002 through February 2003, reference numbers 170-192 (calls) and 194-216 (puts) respectively.

By way of example, the operation of a delayed start call option 180 and a delayed start put option 204 having August 2002 expirations will now be explained. The delayed start call option 180 and the delayed start put option 204 are both three month delayed start options. Thus, the strike price setting date for each will be three months prior to the August expiration date. In other words, the strike price setting date for August expiration delayed start options will be the Saturday following the third Friday of May 2002. Prior to the strike price setting date, the strike price of the delayed start options will float with the value of the underlying asset 162. On the strike price setting date, however, the delayed start call option 180 will convert to one of the standard call options 108 and the delayed start put option 204 will convert to one of the standard put options 110. The standard call and put options to which the delayed start call and put option 180, 204 convert will be the standard call and put options for the same underlying asset having a strike price nearest the closing value of the underlying asset 162 on the strike price setting date. For example, suppose that the closing value of the Dow Jones Index on the strike price setting date is 100.8 (see FIG. 1 Ref. No. 103). Referring to FIG. 2, the DJX-E Index standard call option having a strike price nearest the 100.8 value of the index is standard call option 114 having a 101.0 strike price and the standard put option having a strike price nearest 100.80 is standard put option 132 also having a 101.0 strike price. Therefore, a delayed start call option for August expiration will convert to a standard call option 114 with a strike price of 101.00 on the strike price setting date, and a delayed start put option for August expiration will convert to a standard put option 132, also having a strike price of 101.00. Special rounding rules may be applied if the value of the underlying asset falls exactly between the strike prices of the two standard options having strike prices nearest the value of the underlying asset. Furthermore, different converting rules may also be applied, such as always converting to a standard option having a strike price nearest to and below the value of the underlying asset, or nearest to and above the value of the underlying asset, and so forth.

A problem arises when converting the delayed start option into a standard option in that the value of a three month call option with a strike price of 100.80 is greater than the value of a three month call option with a strike price of 101.00. Similarly, the value of a three month put option with a strike price of 100.80 is less than the value of a three month put option with a 100.00 strike price. When the delayed start call options are converted to standard options having strike prices nearest the value of the underlying asset, a loss is incurred by one party to the transaction and a gain is realized by the other. In the example given above, the investor who is long a delayed start call option at 100.80 loses an amount equal to the difference in value between a call option having a strike price of 100.8 and a call option having a strike price of 101.00. An investor who is short a delayed start call option at 100.80 gains a similar amount. If, on the other hand, the strike price were rounded down to 100.00 rather than up 101.00, the positions of the parties to the transaction would be reversed. The long investor would receive the windfall from a favorable conversion, and the short investor would suffer the loss.

The situation is reversed when a delayed start put option is converted into a standard put. If the strike price is rounded up, the long investor realizes a gain, while the short investor suffers a loss. Conversely, if the strike price is rounded down, the short investor gains and long investor loses. In order to make the delayed start option an attractive investment, such random rounding gains and losses must be accounted for and allocated fairly between the parties to each transaction.

According to the present invention, long and short investors are to receive a cash adjustment to compensate for the difference in value between an option having a strike price equal to the value of the underlying asset and the value of the standard option to which the delayed start option is converted. In a preferred embodiment of the invention, the cash adjustment is determined by calculating the difference between the closing price of the underlying asset on the strike price setting date and the strike price of the standard option to which the delayed start option is being converted, and multiplying the difference by 0.5. This value represents the approximate delta of an at-the-money option [Do you think it is necessary to define “delta”]. If the strike price of the converted delayed start option is set higher than the value of the underlying asset, long call holders and short put holders will receive a credit, and short call holders and long put holders will be required to pay a debit. Conversely, if the strike price of the converted delayed start option is set lower than the value of the underlying asset, short call holders and long put holders will receive a credit, whereas long call holders and short put holders will be required to pay a debit.

Once the strike price has been set, the delayed start option trades as a standard option. The trading symbol of the delayed start option will be changed to that of the standard option, and the strike price code will match that of the standard option as will the actual strike price. The month code will not change.

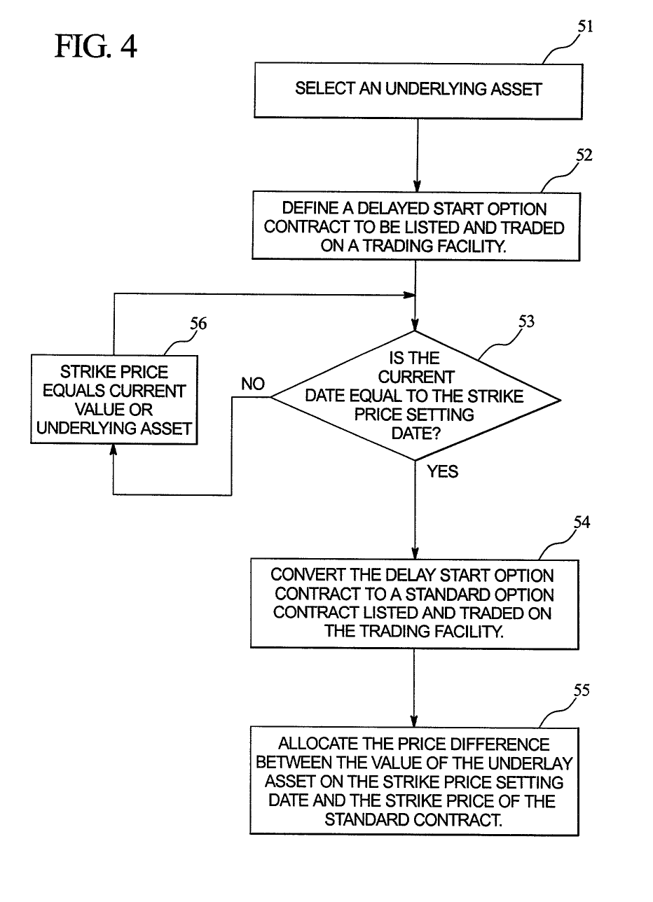

The series of steps required for creating a delayed start option and converting it into a standard option are shown in the flowchart of FIG. 4. The process begins at step S1 by selecting an underlying asset. As described above, the underlying asset may be a security, a commodity, a market index, interest rates, derivative or almost anything which has a value that may be tracked and will change over time depending on market conditions. The delayed start option is defined in step S2 and listed on an exchange or other trading facility. Defining the delayed start option requires the identification of the underlying asset, selecting the expiration date and the strike price setting date.

Once the delayed start option has been defined, including the strike price setting date, a determination is made at step S3 whether the current date is the strike price setting date. If not, the process moves to step S6 where the strike price is set to the current value of the underlying asset. In other words, the delayed start option remains at-the-money prior to the strike price setting date regardless of the value of the underlying asset. If, however, at step S3 it is determined that the current date is the strike price setting date, the process moves to step S4.

In step S4 the delayed start option is converted to a standard option as described above. Typically, the value of the underlying asset used in converting the delayed start option will be the closing value of the underlying asset on the strike price setting date. Finally, at step S5 the difference in value between the standard option having a strike price nearest the value of the underlying asset on the strike price setting date and an at the money option having a strike price equal to the value of the underlying asset is calculated and allocated between the parties to the transaction. Thereafter, the instrument may be traded as a standard option listed by the exchange or trading facility.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A financial instrument adapted to be listed and traded on a trading facility on which a plurality of standard options are listed and traded, said financial instrument comprising:
an underlying asset having a variable value;
a delayed start option to either buy or sell a stake in the underlying asset at a strike price to be determined on a strike price setting date which occurs a predefined length of time prior to an expiration date of said delayed start option;
said strike price being determined on the strike price setting date by converting the delayed start option to a standard option having a fixed strike price at or near the value of the underlying asset on the strike price setting date.

2. The financial instrument of claim 1 wherein the underlying asset comprises a tangible asset.

3. The financial instrument of claim 2 wherein the tangible asset is a security.

4. The financial instrument of claim 2 wherein the tangible asset is a commodity.

5. The financial instrument of claim 2 wherein the tangible asset is a bond or note.

6. The financial instrument of claim 2 wherein the tangible asset is an exchange traded fund.

7. The financial instrument of claim 2 wherein the underlying asset is an intangible asset.

8. The financial instrument of claim 7 wherein the intangible asset is a market index.

9. The financial instrument of claim 7 wherein the intangible asset is a derivative.

10. The financial instrument of claim 1 wherein said delayed start option comprises a call option.

11. The financial instrument of claim 1 wherein said delayed start option comprises a put option.

12. The financial instrument of claim 1 wherein said strike price setting date is three months prior to the expiration date.

13. The financial instrument of claim 1 wherein said strike price setting date is 30 days prior to the expiration date.

14. The financial instrument of claim 1 wherein said strike price setting date is two months prior to the expiration date.

15. The financial instrument of claim 1 wherein the standard option to which the delayed start option is converted is a standard option from among said plurality of standard options having a fixed strike price nearest the value of the underlying asset on the strike price setting date.

16. The financial instrument of claim 1 wherein the standard option to which the delayed start option is converted is the standard option from among said plurality of standard options having a fixed strike price nearest to and less than the value of the underlying asset.

17. The financial instrument of claim 1 wherein the standard option to which the delayed start option is converted is a standard option from among said plurality of standard options having a fixed strike price nearest to and greater than the value of the underlying asset on the strike price setting date.

18. A method of creating an option that will be at-the-money on a strike price setting date a predefined period of time prior to expiration of the option, and which may be held and traded prior to the strike price setting date, the method comprising the steps of:
selecting an underlying asset having a variable value;
listing a plurality of standard options to either buy or sell a stake in the underlying asset at a fixed strike price;
creating a delayed start option to either buy or sell a stake in the underlying asset at a strike price to be determined on a predefined strike setting date in the future; and
converting said delayed start option to a standard option selected from said plurality of standard options having a fixed strike price at or near the value of the underlying asset on the strike price setting date, thereby creating a standard at-the-money option as of the strike price setting date.

19. The method of claim 18 wherein the step of converting the delayed start option contract further comprises the steps of identifying first and second standard option contracts having respective first and second standard option strike prices above and below the variable strike price of the delayed start option contract on the strike price setting date, and converting the delayed start option contract into one of said first and second identified standard option contracts.

20. The method of claim 19 wherein the step of converting the delayed start option contract comprises converting the delayed start option contract into one of the first and second identified standard option contracts having a standard option strike price nearest the variable strike price of the delayed start option contract on the strike price setting date.

21. The method of claim 19 wherein the step of converting the delayed start option contract comprises converting the delayed start option contract into one of the first and second identified standard option contracts having a standard option strike price nearest and above the variable strike price of the delayed start option contract on the strike price setting date.

22. The method of claim 19 wherein the step of converting the delayed start option contract comprises converting the delayed start option contract into one of the first and second identified standard option contracts having a standard option strike price nearest and below the variable strike price of the delayed start option contract on the strike price setting date.

23. The method of claim 18 further comprising the step of allocating the difference in value between an option having a strike price equal to the value of the underlying asset and the value of the standard option to which the delayed start option is converted between a long party and a short party.

24. The method of claim 23 wherein the step of allocating the difference in value comprises calculating a cash adjustment by taking the difference between the closing value of the underlying asset on strike price setting date and the fixed strike price of the standard option to which the delayed start option is converted and multiplying the difference by one half.

25. The method of claim 24 wherein the step of allocating the difference in value between an option having a strike price equal to the value of the underlying asset and the value of the standard option to which the delayed start option is converted comprises granting a credit to the long party to a delayed start call option and charging a debit to the short party to the delayed start call option in an amount equal to the cash adjustment if the fixed strike price of the standard option to which the delayed start option is converted is greater than the closing value of the underlying asset on the strike price setting date.

26. The method of claim 24 wherein the step of allocating the difference in value between an option having a strike price equal to the value of the underlying asset and the value of the standard option to which the delayed start option is converted comprises granting a credit to the short party to a delayed start call option and charging a debit to the long party to the delayed start call option in an amount equal to the cash adjustment if the fixed strike price of the standard option to which the delayed start option is converted is less than the closing value of the underlying asset on the strike price setting date.

27. The method of claim 24 wherein the step of allocating the difference in value between an option having a strike price equal to the value of the underlying asset and the value of the standard option to which the delayed start option is converted comprises granting a credit to the long party to a delayed start put option and charging a debit to the short party to the delayed start put option in an amount equal to the cash adjustment if the fixed strike price of the standard option to which the delayed start option is converted is less than the closing value of the underlying asset on the strike price setting date.

28. The method of claim 24 wherein the step of allocating the difference in value between an option having a strike price equal to the value of the underlying asset and the value of the standard option to which the delayed start option is converted comprises granting a credit to the short party to a delayed start put option and charging a debit to the long party to the delayed start put option in an amount equal to the cash adjustment if the fixed strike price of the standard option to which the delayed start option is converted is greater than the closing value of the underlying asset on the strike price setting date.

29. A method for converting a delayed start option contract based on an underlying asset having a variable value to a standard option contract traded on an exchange, the method comprising the steps of:
determining a strike price for the delayed start option contract on a strike setting date;
identifying a category of standard option contracts traded on the exchange based on the same underlying asset as the delayed start option contract, having an expiration date that is the same as the expiration date of the delayed start option contract, and having a strike price near the value of the underlying asset on the strike setting date, and;
converting the delayed start option contract into a standard option contract belonging to the identified category of standard option contracts.
